(19) United States
(12) Patent Application Publication
(10) Pub. No.: US 2007/0012778 A1
(43) Pub. Date: Jan. 18, 2007

(54) Image preprocessing method and apparatus for improving hot code recognition rate

(75) Inventor: Seung Cheol Lee, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/485,239

(22) Filed: Jul. 12, 2006

(30) Foreign Application Priority Data
Jul. 12, 2005 (KR) 10-2005-0062993

(51) Int. Cl. G06K 7/10

(52) U.S. Cl. 235/454

(57) ABSTRACT

An image preprocessing function for improving a hot code recognition rate. To implement this function, when a hot code pattern is input, by making a dark portion darker and a bright portion brighter so that an edge portion between black and white is more clearly identified, a difference between the hot code pattern and its background is clarified. Accordingly, an improved hot code recognition rate can be obtained.

### PRIORITY

This application claims priority under 35 U.S.C. § 119 to an application entitled “Image Preprocessing Method and Apparatus for Improving Hot Code Recognition Rate” filed in the Korean Intellectual Property Office on Jul. 12, 2005 and assigned Serial No. 2005-62993, the contents of which are incorporated herein by reference.

### BACKGROUND OF THE INVENTION

1. Field of the Invention

The present invention relates generally to an image preprocessing method and apparatus for improving a hot code recognition rate.

2. Description of the Related Art

A 3^{rd} generation mobile communication technology has been realized providing a mobile communication terminal in which a central processing unit (CPU) having a fast communication speed and an excellent calculation capability is equipped. As a result, wireless Internet can be conveniently used as if it were wired Internet. However, unlike a personal computer (PC) or a laptop computer, it is difficult to conveniently input mass information using the mobile communication terminal due to the limitation in a terminal size, thereby resulting in inconvenience in the use of the Internet. Hot code is a technique suggested as one of methods for reducing this inconvenience.

Hot code is a service of directly connecting to wireless Internet content or shopping content corresponding to a barcode printed on a newspaper, a magazine, or a leaflet when a user holds the barcode up to a camera equipped in the user's mobile communication terminal. In other words, the hot code is a method of inputting a predetermined Internet address represented using a 2-dimensional (2D) code in a browser as soon as the user holds the Internet address up to the camera, without an additional key input.

In detail, the hot code is a method of allowing a user to use various wireless Internet services by inputting a 2D black and white code image using a camera equipped in a mobile communication terminal having a multimedia function, analyzing this image as a number string, and accessing a wireless Internet network using the number string. The hot code is made up of a 2D black and white image having at least 9×9 pixels, i.e., black lines on a white ground, and is a method of decoding a specific number string based on whether a valid black pixel exists at a specific location when an image greater than a predetermined size is input through a camera. According to a hot code specification provided by a general mobile communication provider, an output value of the hot code is obtained by processing a black and white image having at least 120×90 pixels input through a camera in a processing unit using a predetermined recognition algorithm.

Among various kinds of cameras, an image is normally input for a camera having a typical infinite focus distance, and an image is input through a close-up function for a camera having a multi-focus lens. A camera having such a function, which is equipped in a terminal, plays a role of a digital camera and an input unit of a wireless Internet. Thus, a camera for accessing the wireless Internet must process all general images and black and white images at a close distance. Because of this, in general, a trade-off time between image quality of a general image and image quality of a black and white image is determined by tuning the camera.

In general, most camera modules used for mobile communication terminals use only a single focus lens due to packaging considerations. The single focus lens is designed to best represent a subject located farther than the focus distance. When a black and white code, such as a hot code, at a distance around 15 cm apart from the single focus lens is input as an image, the image is not in complete focus. Accordingly, quality of the image decreases. When a poor quality black and white image is input to a hot code recognition processing unit, the recognition is not normally accomplished, and accordingly, the hot code cannot be analyzed.

Thus, when a hot code of a binary image made up of only 0 and 256 levels, which is illustrated in FIG. 1A, passes through a camera, its recognition rate is so low that edges of a hot code pattern can hardly be identified as illustrated in FIG. 1B. As described above, in a hot code service, a technique of increasing a recognition rate for a terminal to recognize a hot code or barcode is most important.

According to the prior art, only when a focus distance is designed to be sufficiently long in a single focus lens equipped camera, a hot code image obtained by photographing a black and white hot code subject at a close distance is restored closest to the original. In this case, if the time taken for image processing is required to be long, a realtime characteristic is lost, and thus the Internet cannot be smoothly used. Accordingly, an algorithm for clarifying a hot code through a simple calculation is required.

In addition, according to a camera characteristic, since contrast and sharpness significantly decrease in a dark environment with too low a resolution and too low a color temperature, more image processing procedures are required. Because of this, for a subject exposed in light having a strong low frequency component, such as a dark environment, a glow in the sky, a glow lamp, or a small-sized input image, it is difficult to improve its recognition rate.

### SUMMARY OF THE INVENTION

An object of the present invention is to substantially solve at least the above problems and/or disadvantages and to provide at least the advantages below. Accordingly, an object of the present invention is to provide an image preprocessing method and apparatus for improving a hot code recognition rate by adaptively processing the hot code recognition even under a condition of a dark environment or a low color temperature.

According to one aspect of the present invention, there is provided an image preprocessing method for improving a hot code recognition rate, the method including setting a predetermined area of an image of a YCbCr format (a family of color spaces used in video systems) and sampling the predetermined area; calculating a value of each pixel in the predetermined area by interpolating and clipping Y and Cb data of the sampled predetermined area, and accumulating the calculated pixel value; calculating an average value indicating average brightness of the image using the accumulated pixel value when the sampling of the predetermined area is finished; and recognizing an image of a hot code pattern by expanding the level of the image based on the average value.

According to another aspect of the present invention, there is provided an image preprocessing method for improving a hot code recognition rate, the method including converting an image of an Red-Green-Blue (RGB) format (a family of color spaces used in video systems) to an image of a YCbCr format, setting a predetermined area of the converted image, and sampling the predetermined area; calculating a value of each pixel in the predetermined area by applying pre-set weights to Y and Cb data of the sampled predetermined area, interpolating the weight applied to the Y and Cb data, and clipping a pixel value exceeding a predetermined range as the interpolation result, and accumulating the calculated pixel value; calculating average brightness of the image using the accumulated pixel value when all pixel values in the predetermined area are calculated; and recognizing an image of a hot code pattern by expanding the level of the image based on the average brightness.

According to another aspect of the present invention, there is provided an image preprocessing apparatus for improving a hot code recognition rate, the apparatus including an image input unit for inputting an image of an RGB format; a controller for converting the input image to an image of a YCbCr format, and setting a predetermined area of the converted image; a pixel value calculator for calculating a value of each pixel in the predetermined area by applying pre-set weights to Y and Cb data of the predetermined area, interpolating the weight applied to the Y and Cb data, and clipping a pixel value exceeding a predetermined range as the interpolation result; and a pixel value storage unit accumulating and storing the result of the pixel value calculation, wherein when all pixel values in the predetermined area are calculated, the controller calculates an average brightness of the image using the accumulated pixel value and recognizes an image of a hot code pattern by expanding the level of the image based on the average brightness.

### BRIEF DESCRIPTION OF THE DRAWINGS

The above and other objects, features and advantages of the present invention will become more apparent from the following detailed description when taken in conjunction with the accompanying drawings in which:

FIG. 1A illustrates a typical hot code pattern;

FIG. 1B illustrates an image of the hot code pattern of FIG. 1A, which is recognized according to a conventional processing method;

FIG. 2 is an internal block diagram of a mobile communication terminal performing a function of preprocessing an image of a hot code pattern, according to the present invention;

FIG. 3 is a flowchart of a method of preprocessing an image of a hot code pattern, according to the present invention;

FIG. 4 is a diagram for explaining a method of obtaining a duration using a histogram according to the present invention;

FIG. 5 is a diagram for explaining a method of expanding a level according to the present invention; and

FIG. 6 illustrates an image of a hot code pattern recognized according to the present invention.

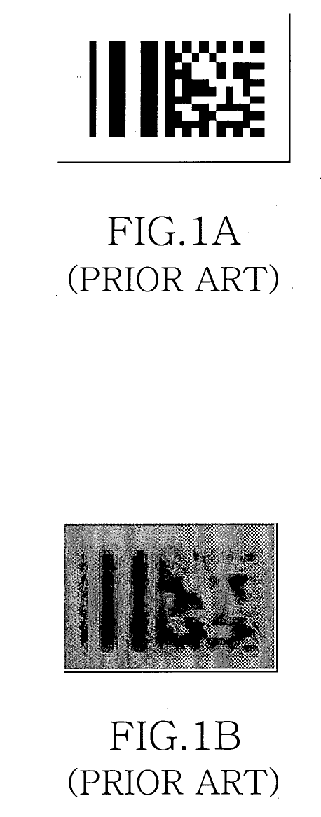

### DETAILED DESCRIPTION OF THE PREFERRED EMBODIMENT

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail since they would obscure the invention in unnecessary detail.

The present invention implements an image preprocessing function for improving a hot code recognition rate. When a hot code pattern is input, recognition of the hot code pattern is improved by clarifying a difference between the hot code pattern and its background, by making a dark portion darker and a bright portion brighter to more clearly recognize an edge portion between a black area and a white area. In this case, an image of the hot code pattern sensed by a camera has an RGB format, and the input hot code pattern is converted to a YUV, i.e., YCbCr color space.

Prior to the description of the present invention, YUV used in the present invention will now be described in brief.

A YUV method is a method based on the principle that human eyes are more sensitive to brightness than to a color tone, and YUV is classified into a Y component indicating the brightness of color (Y: luminance), a U component indicating the degree of blue color (Cb: chrominance), and a V component indicating the degree of red color (Cr: redness). In detail, Y data indicates brightness data, i.e., black and white series data, of an image used in pattern recognition, Cb data indicates blue data having a high frequency data component characteristic included in pattern data, and Cr data indicates red data having a low frequency data component characteristic included in the pattern data. In a conventional method of recognizing an image of a hot code pattern, the image of a hot code pattern is recognized using only Y data among extracted Y, Cb, and Cr data, and a user is allowed to use an operation corresponding to the recognized pattern image, i.e., wireless Internet content or shopping content.

When an unfocused, vague black and white image is obtained due to close-up photographing at a distance shorter than a camera focusing distance, if there exist requirements that an image can be recognized only if black color and white color are clearly identified as in the case of hot code, it is difficult to use the unfocused, vague black and white image as it is. To solve this problem, efforts are required to convert a deteriorated image to an image of an easily recognizable format without changing a state set optimally to a camera lens or general images.

Recently, accompanying transmission of an image having more than million pixels or image quality compensation through image processing in the use of a camera, the load actually added on to a central processing unit (CPU) or a system bus has increased. In this state, if the amount of an image processing calculation is increased to improve a hot code recognition rate, a usage rate of a hot code service may decrease due to problems such as occurrence of delay. Thus, an algorithm is required to process an image through a simple calculation without increasing the amount of an image processing calculation even in a state in which the hot code recognition rate decreases under a condition of a dark environment or a low color temperature.

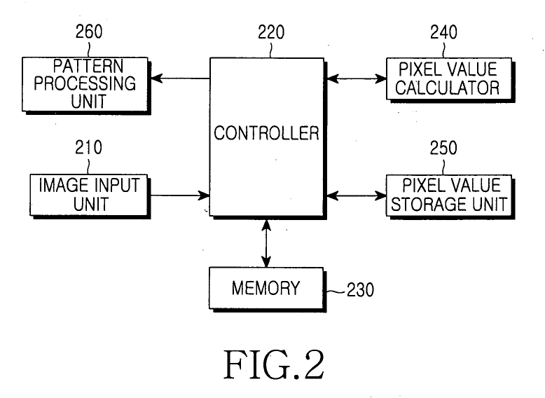

FIG. 2 is an internal block diagram of a mobile communication terminal performing a function of preprocessing an image of a hot code pattern, according to the present invention.

Referring to FIG. 2, the mobile communication terminal includes an image input unit 210, a controller 220, a memory 230, a pixel value calculator 240, a pixel value storage unit 250, and a pattern processing unit 260.

The image input unit 210, made up of a camera module, photographs an image in response to a key input by a user. When the user photographs a hot code pattern through the image input unit 210, an image sensed through the image input unit 210 has an RGB format. A predetermined sensing sensor (not shown) may be included in the image input unit 210 to determine whether the input image is a hot code pattern image. In this case, if the image input through the image input unit 210 is recognized as a hot code pattern image, the controller 220 converts the input RGB format hot code pattern image to a YCbCr color space.

The controller 220 controls a general function related to image processing of a hot code pattern according to a preferred embodiment of the present invention. In detail, if an RGB format image is sensed as a hot code pattern image, the RGB format image is converted to Y, Cb, and Cr data. Herein, the controller 220 converts the RGB format image to the Y, Cb, and Cr data so that the Y, Cb, and Cr data have 256 levels per channel. Then, the controller 220 obtains an average brightness of the input hot code pattern image. The average brightness is represented using a Y component.

For example, when the input image has the size of 320×240 pixels, an average Y is obtained using a result derived by sampling the Y component at a constant interval from the center. Herein to reduce the amount of a calculation load according to the image processing, the calculation is performed by sampling the Y component at the constant interval without calculating over the entire image. Thus, the size of the sampled image can vary according to a consideration of the amount of the calculation load. Energy of the entire hot code pattern image is predicted using the sampling result. In particular, in the current embodiment, by obtaining the average brightness and using the obtained average brightness, a characteristic robust even to light and shade (i.e., bright and dark, environment around a subject) can be obtained.

When the average Y (i.e., the average brightness, of the entire image is obtained), this value is temporarily stored in the memory 230. The memory 230 connected to the controller 220 includes Read Only Memory (ROM), Random Access Memory (RAM), and voice memory for storing a plurality of programs and information required when an operation of the mobile communication terminal is controlled. In particular, the memory 230 stores an application required to perform a process of preprocessing the image of a hot code pattern according to a preferred embodiment of the present invention. When a calculation is performed according to a preferred embodiment of the present invention, the memory 230 stores intermediate values of the calculation process.

In a subsampling of pixels at a constant ratio in a predetermined area of the input image according to a preferred embodiment of the present invention, the controller 220 controls the pixel value calculator 240 to extract the Y data, which is a brightness component, and the Cb data, which is a high frequency component, among the Y, Cb, and Cr data; apply pre-set weights to the Y data and the Cb data; and interpolate the weight applied Y and Cb data. A value smoothly varies near an edge of a binary image whose Y data value has a low frequency. To compensate for this, a weight (e.g., 75% or 80%) higher than that of the Y data value is applied to the Cb data value to which a phase of 128 is added, and a weight of 50% or less is applied to the Y data value.

As described above, by interpolating the pre-set weight applied to Y and Cb data, a difference between values near a boundary edge between areas identified as black and white can be great, and an entire phase can be increased. In this case, since each of the data values may exceed a predetermined range and be saturated due to the applied weights, each of the data values is clipped by applying the upper limit value 0×ff (255) and the under limit value 0×00 (0) thereto. By doing this, a bright signal and a dark signal are enlarged in relevant directions by setting predetermined brightness as the center based on a high frequency component. Accordingly, a dark color and a background white color can be clearly identified with robustness to the brightness of the entire image. In the current embodiment, a high pass filter effect can be obtained through the signal enlargement.

As described above, the pixel value calculator 240 obtains a value of each pixel by interpolating and clipping a Y component signal and a Cb component signal.

When each pixel value in the image is obtained through the interpolation and clipping, the pixel value calculator 240 temporarily accumulates and stores the obtained pixel value in the pixel value storage unit 250 via the controller 220. When the subsampling is finished by repeating the above procedures in the predetermined area, the controller 220 calculates an average value, i.e., the average brightness, of the hot code pattern image using the accumulated pixel value stored in the pixel value storage unit 250. That is, when the subsampling of the predetermined area is finished, the average brightness of the predetermined area can be obtained using values of pixels in the predetermined area.

Since a high frequency portion of the binary image is cancelled and energy of the binary image is lowered, a value between the black color and the white color of the hot code pattern is smoothed through the calculation according to a preferred embodiment of the present invention, and thereby a phase of the boundary portion can be increased, but the entire phase is higher.

Thus, a reference value is obtained by subtracting a camera image characteristic value (e.g., 25) from the average brightness, and a dark value is made darker by decreasing a value lower than the reference value at the ratio of 75%. That is, by expanding a level difference between pixels up to a range of 0˜255, a dark portion becomes darker, and a bright portion becomes brighter, thereby clarifying a difference between the hot code pattern and the background, and also clarifying the boundary between them. Accordingly, the pattern processing unit 260 can easily recognize and determine the hot code pattern.

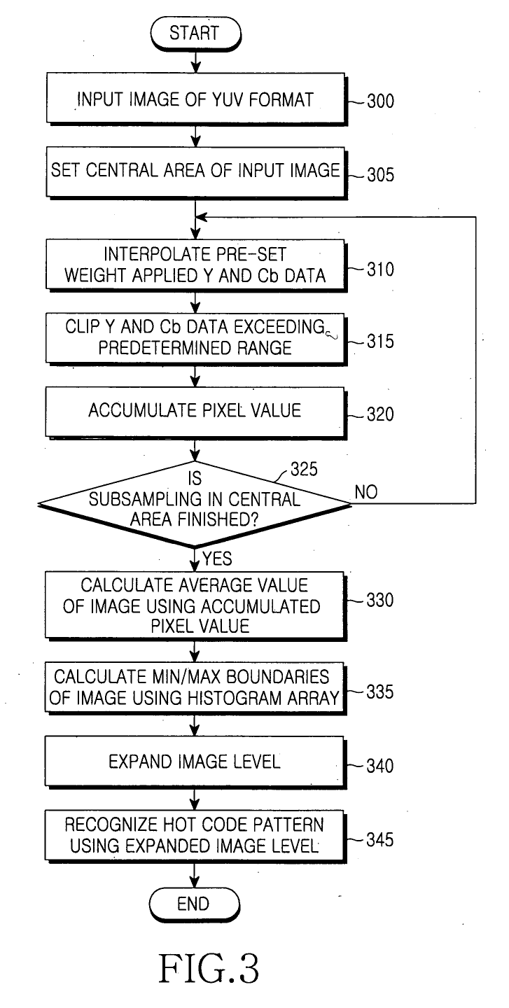

A method of preprocessing an image of a hot code pattern in the mobile communication terminal in which the above-described function is implemented will now be described with reference to FIG. 3.

When a hot code pattern subject is photographed by a user, in step 300, the controller 220 inputs an image converted to a YUV format. In step 305, the controller 220 sets a central area of the input image and starts subsampling of the central area. Herein, the central area may be a square of ¼ the size of the entire image, and the controller 220 subsamples pixels of an image in the set central area at a predetermined ratio by extracting the image of the predetermined ratio. In step 310, the controller 220 controls the pixel value calculator 240 to interpolate Y and Cb data of a subsampled pixel of the image using pre-set weights. It is preferable that the procedures described below be achieved by the controller 220 controlling components related to the hot code pattern image preprocessing. However, for the convenience of the description, the procedures described below will be described based on the controller 220.

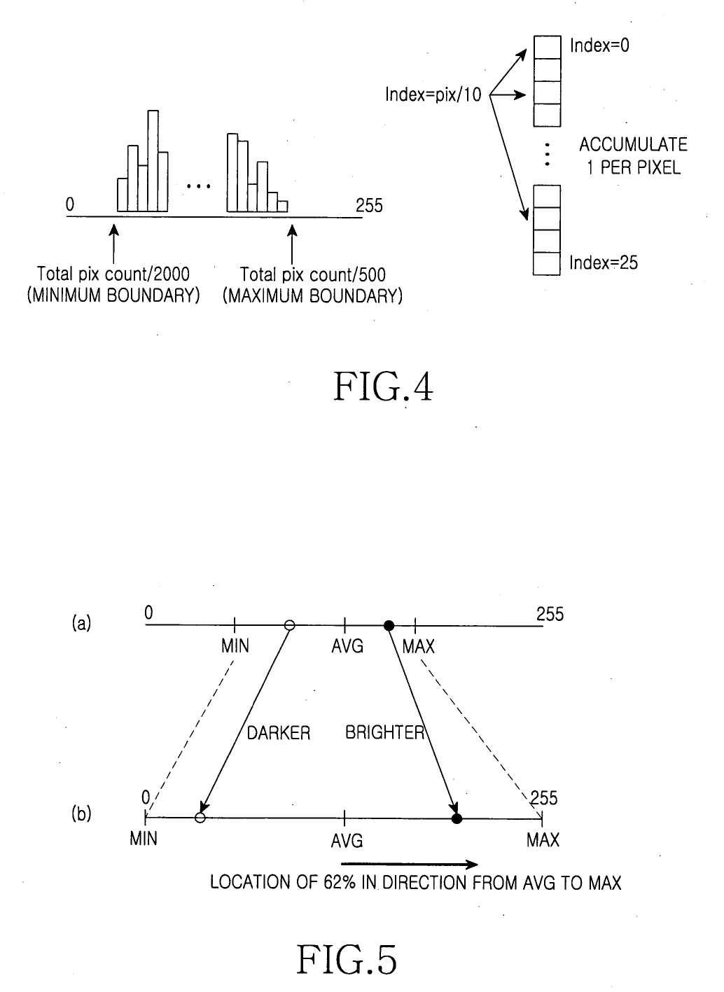

Since saturation may occur in the interpolation, in step 315, the controller 220 clips each of Y and Cb data exceeding a predetermined value range, i.e., a saturation range, thereby having a value within 0˜255. In step 320, the controller 220 accumulates a value of the pixel. When accumulating the pixel value, a value of 1/10 the pixel level is set as index, and a value corresponding to each index in a histogram array is increased by 1. In other words, as illustrated in FIG. 4, 256 levels in the histogram are set to levels of index 0 to index 25, and each pixel is accumulated using the index 0 to index 25. FIG. 4 is a diagram for explaining a method of obtaining a duration using a histogram according to a preferred embodiment of the present invention.

In step 325, the controller 220 determines whether the subsampling in the central area is finished. If the subsampling is finished as the determination result, in step 330, the controller 220 calculates an average value of the image, i.e., the average brightness, using the accumulated pixel value. In step 335, the controller 220 calculates maximum and minimum boundaries MAX and MIN illustrated in FIG. 5A using the histogram array. In step 340, the controller 220 expands the image level by enlarging a bright signal and a dark signal in relevant directions based on the average brightness AVG as illustrated in FIG. 5B. Accordingly, a dark portion becomes darker, and a bright portion becomes brighter. In step 345, the controller 220 can recognize the hot code pattern through the expanded image level.

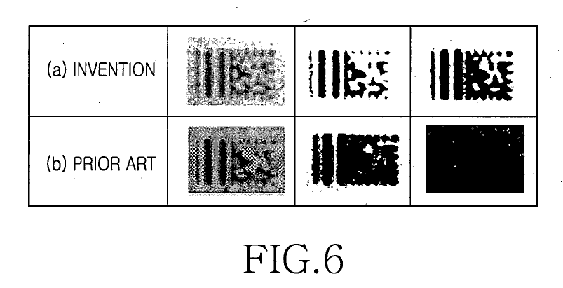

When the above-described method of preprocessing an image of a hot code pattern is used, in an unaccommodating hot code recognition environment, e.g., brightness of 200 lux and color temperature of 2700 K, an image after preprocessing and a predicted binary image are illustrated in FIG. 6A. When the results illustrated in FIG. 6A are compared to the results illustrated in FIG. 6B obtained by using a conventional processing method, each boundary between black and white is clear. Therefore, a hot code recognition rate improvement effect can be expected.

As described above, according to the embodiments of the present invention, since image processing can be adaptively performed, the image processing is robust in a dark environment or a low color temperature condition. In addition, since an edge portion of a hot code pattern is more clearly identified by making a dark portion darker and a bright portion brighter, a hot code recognition rate can be improved. In particular, a load according to image calculation can be reduced by sampling a portion of the entire image.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An image preprocessing method for improving a hot code recognition rate, the method comprising the steps of:
setting a predetermined area of an image of a Luminance-Chrominance-Redness (YCbCr) format and sampling the predetermined area;
calculating a value of each pixel in the predetermined area by interpolating and clipping Y and Cb data of the sampled predetermined area, and accumulating the calculated pixel value;
calculating an average value indicating average brightness of the image using the accumulated pixel value when the sampling of the predetermined area is finished; and
recognizing an image of a hot code pattern by expanding the level of the image based on the average value.

2. The image preprocessing method of claim 1, wherein the step of calculating and accumulating each pixel value comprises:
interpolating the Y and Cb data by applying pre-set weights to the Y and Cb data;
clipping a value exceeding a predetermined range in the interpolation; and
when each pixel value is obtained through the interpolation and the clipping, temporarily accumulating and storing the obtained pixel value.

3. The image preprocessing method of claim 2, further comprising setting a value of 1/10 pixel level as an index and sequentially increasing a value corresponding to each index in a histogram array.

4. The image preprocessing method of claim 2, wherein, in the step of interpolating, the interpolation is performed by applying a weight of up to 50% to the Y data and applying a weight higher than that of the Y data to the Cb data.

5. The image preprocessing method of claim 2, wherein the predetermined range is a value of 0 to 255.

6. The image preprocessing method of claim 1, wherein the step of recognizing an image of a hot code pattern comprises the steps of:
calculating a minimum boundary and a maximum boundary of the image using a histogram array; and
enlarging the minimum boundary and the maximum boundary in relevant directions based on the average value.

7. An image preprocessing method for improving a hot code recognition rate, the method comprising the steps of:
converting an image of a Red-Green-Blue (RGB) format to an image of a Luminance-Chrominance-Redness (YCbCr) format, setting a predetermined area of the converted image, and sampling the predetermined area;
calculating a value of each pixel in the predetermined area by applying pre-set weights to Y and Cb data of the sampled predetermined area, interpolating the weight applied Y and Cb data, and clipping a pixel value exceeding a predetermined range as the interpolation result, and accumulating the calculated pixel value;
calculating an average brightness of the image using the accumulated pixel value when all pixel values in the predetermined area are calculated; and
recognizing an image of a hot code pattern by expanding the level of the image based on the average brightness.

8. An image preprocessing apparatus for improving a hot code recognition rate, the apparatus comprising:
an image input unit for inputting an image of an Red-Green-Blue (RGB) format;
a controller for converting the input image to an image of a Luminance-Chrominance-Redness (YCbCr) format, setting a predetermined area of the converted image;
a pixel value calculator for calculating a value of each pixel in the predetermined area by applying pre-set weights to Y and Cb data of the predetermined area, interpolating the weight applied Y and Cb data, and clipping a pixel value exceeding a predetermined range as the interpolation result; and
a pixel value storage unit accumulating and storing the result of the pixel value calculation,
wherein when all pixel values in the predetermined area are calculated, the controller calculates an average brightness of the image using the accumulated pixel value and recognizes an image of a hot code pattern by expanding the level of the image based on the average brightness.

9. The image preprocessing apparatus of claim 8, wherein the pixel value calculator interpolates the Y and Cb data by applying a weight of up to 50% to the Y data and applying a weight higher than that of the Y data to the Cb data.

10. The image preprocessing apparatus of claim 8, wherein the pixel value calculator expands the image level by calculating a minimum boundary and a maximum boundary of the image using a histogram array and enlarging the minimum boundary and the maximum boundary in relevant directions based on the average value.
